(19) United States
(12) Patent Application Publication
(10) Pub. No.: US 2018/0259714 A1
(43) Pub. Date: Sep. 13, 2018

(54) OPTICAL DICHROIC ELEMENT AND OPTICAL DICHROIC MODULE

(71) Applicant: ELASER TECHNOLOGIES CO.,LTD., New Taipei City (TW)

(72) Inventors: Chu-Liang Cheng, New Taipei City (TW); Chi-Hua Wang, Taipei City (TW)

(73) Assignee: ELASER TECHNOLOGIES CO.,LTD., New Taipei City (TW)

(21) Appl. No.: 15/649,596

(22) Filed: Jul. 13, 2017

(30) Foreign Application Priority Data
Mar. 10, 2017 (TW) 106107904

(51) Int. Cl. G02B 6/293; G02B 27/14

(52) U.S. Cl. CPC G02B 6/29365; G02B 27/142; G02B 27/141; G02B 6/2938

(57) ABSTRACT

An optical dichroic element adapted to combine first and second light beams into a mixed light beam is provided. The optical dichroic element includes a transparent element, a first reflector and a second reflector. The transparent element is adapted to let the first light beam and the second light beam pass through. The first reflector is disposed on the transparent element. The second reflector is disposed on the transparent element. The first reflector is adapted to reflect the first light beam to the second reflector. The second reflector is adapted to reflect the first light beam and let the second light beam pass through. The first reflector and the second reflector are opposite and not parallel to each other on the transparent element, and an included angle is provided between the first reflector and the second reflector. Moreover, an optical dichroic module including the optical dichroic element is also provided.

### CROSS REFERENCE TO RELATED APPLICATION

This application claims the priority benefit of Taiwan application serial no. 106107904, filed on Mar. 10, 2017. The entirety of the above-mentioned patent application is hereby incorporated by reference herein and made a part of specification.

### BACKGROUND OF THE INVENTION

### 1. Field of the Invention

The invention relates to an optical element, and more particularly, to an optical dichroic element.

### 2. Description of Related Art

With advancements in communication technologies, communication methods are no longer limited by implementation using electrical signals. In recent technological development, optical communication technologies have been developed to realize signal transmission with optical signals. Because transmission speed and distance of light in fiber is far higher and longer than electrons, optical communication technologies have gradually become the mainstream in the market. Therefore, based on high bandwidth requirements, demands for optical transceiver modules capable of transmitting massive amount of optical signal also become higher each day.

However, costs in deployment of optical cables can be fairly expensive. Correspondingly, when optical signals transmittable within one optical cable are to be increased, other than increasing signal frequency, it often requires light rays with various wavelengths to be introduced and combined within the same optical fiber cable in order to significantly increase signal transferring amount. A wavelength division multiplexer (WDM) is one of solutions to achieve such objective. Nonetheless, the existing wavelength division multiplexer involves numerous components, which lead to higher costs and lower yield rate in the manufacturing process due to complexity in terms of configuration. Therefore, how to provide the wavelength division multiplexer designed with simple architecture, lesser space occupied in the device and wider application for multiple devices has long been an issue to be addressed by persons skilled in the art.

### SUMMARY OF THE INVENTION

The invention provides an optical dichroic element with simple structure and lesser occupied space in a light beam integration system.

The invention also provides an optical dichroic module with simple structure and lesser occupied space in a light beam integration system.

The optical dichroic element of the invention is adapted to combine a first light beam and a second light beam into a mixed light beam. The optical dichroic element includes a transparent element, a first reflector and a second reflector. The transparent element is adapted to let the first light beam and the second light beam pass through. The first reflector is disposed on the transparent element. The second reflector is disposed on the transparent element. The first reflector is adapted to reflect the first light beam to the second reflector. The second reflector is adapted to reflect the first light beam and let the second light beam pass through. The first reflector and the second reflector are opposite and not parallel to each other on the transparent element, and an included angle is provided between the first reflector and the second reflector.

In an embodiment of the invention, wavelengths of the first light beam and the second light beam are different from each other.

In an embodiment of the invention, a coating for reflecting a preset wavelength light beam is provided on the second reflector, and a wavelength of the preset wavelength light beam is identical to the wavelength of the corresponding first light beam.

In an embodiment of the invention, the optical dichroic element is also adapted to separate the mixed light beam into the first light beam and the second light beam.

The optical dichroic module of the invention is adapted to provide a mixed light beam. The optical dichroic module includes a plurality of optical dichroic elements, which are adapted to combine a plurality of first light beams and a second light beam into the mixed light beam. The optical dichroic elements are disposed on a transmission path of the second light beam. Each optical dichroic element includes a transparent element, a first reflector and a second reflector. The transparent element is adapted to let the first light beam and the second light beam pass through. The first reflector is disposed on the transparent element. The second reflector is disposed on the transparent element. The first reflector is adapted to reflect one of the first light beams or the second light beam to the second reflector. The first reflector and the second reflector are opposite and not parallel to each other on the transparent element, and an included angle is provided between the first reflector and the second reflector.

In an embodiment of the invention, wavelengths of the first light beams and the second light beam are all different from one another.

In an embodiment of the invention, the transparent element includes one polygon transparent prism.

In an embodiment of the invention, the first reflector and the second reflector are surface coatings of the transparent element.

In an embodiment of the invention, the transparent element includes a polygon frame.

In an embodiment of the invention, the first reflector and the second reflector are formed by a transparent sheet and surface coatings thereon.

In an embodiment of the invention, a coating for reflecting a preset wavelength light beam is provided on the second reflector, and a wavelength of the preset wavelength light beam is identical to a wavelength of the corresponding one of the first light beams or the second light beam.

In an embodiment of the invention, the optical dichroic module further includes a plurality of collimating lens sets, which are respectively disposed on transmission paths of the first light beams and the transmission path of the second light beam.

In an embodiment of the invention, the optical dichroic module further includes a reflective element, which is disposed on the transmission path of the second light beam and adapted to reflect the second light beam to the optical dichroic elements.

In an embodiment of the invention, the optical dichroic module further includes a light beam translating element, which is disposed on a transmission path of the mixed light beam and adapted to translate the mixed light beam.

In an embodiment of the invention, the optical dichroic element is also adapted to separate the mixed light beam into one of the first light beams and the second light beam.

In an embodiment of the invention, the included angle is determined according to the refractive index of the transparent element and a preset incident angle of the second reflector.

In an embodiment of the invention, the optical dichroic module further includes a plurality of first light sources and a second light source. The first light sources are adapted to provide the first light beams. The second light source is adapted to provide the second light beam.

The optical dichroic module of the invention is adapted to separate a mixed light beam. The optical dichroic module includes a plurality of optical dichroic elements, which are adapted to receive the mixed light beam and separate the mixed light beam into a plurality of first light beams and a second light beam. The optical dichroic elements are disposed on a transmission path of the second light beam. Each optical dichroic element includes a transparent element, a first reflector and a second reflector. The transparent element is adapted to let the first light beam and the second light beam pass through. The first reflector is disposed on the transparent element. The second reflector is disposed on the transparent element. The second reflector is adapted to reflect one of the first light beams or the second light beam to the first reflector. The first reflector and the second reflector are opposite and not parallel to each other on the transparent element, and an included angle is provided between the first reflector and the second reflector.

Based on the above, according to the embodiments of the invention, the optical dichroic element includes the transparent element, the first reflector and the second reflector. The first reflector reflects one of the first light beams or the second light beam to the second reflector. The first reflector and the second reflector are opposite and not parallel to each other on the transparent element. One included angle is provided between the first reflector and the second reflector. With aforementioned configuration, the optical dichroic module can have a simple structure, occupy lesser space in other device, and improve precision for transmitting light beams.

To make the above features and advantages of the disclosure more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating an optical dichroic element according to an embodiment of the invention.

FIG. 2 is a schematic diagram illustrating an optical dichroic element according to another embodiment of the invention.

FIG. 3 is a schematic diagram illustrating an optical dichroic module according to an embodiment of the invention.

FIG. 4 is a schematic diagram illustrating an optical dichroic module according to another embodiment of the invention.

FIG. 5 is a schematic diagram illustrating an optical dichroic module according to yet another embodiment of the invention.

FIG. 6 is a schematic diagram illustrating an optical dichroic module according to still another embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

FIG. 1 is a schematic diagram illustrating an optical dichroic element according to an embodiment of the invention. With reference to FIG. 1, in the present embodiment, an optical dichroic element 100 is applicable to various devices that need to integrate light beams with different wavelengths into one single light beam, or can be applied to serve as an element using optical signals with one or more wavelengths, such as optical signal devices including the wavelength division multiplexer, a coarse wavelength division multiplexer (CWDM) or a dense wavelength division multiplexer (DWDM).

In the present embodiment, the optical dichroic element 100 is adapted to combine a first light beam L1 and a second light beam L2 into a mixed light beam LB. Among them, wavelengths of the first light beam L1 and the second light beam L2 are different. The optical dichroic element 100 includes a transparent element 140, a first reflector 150 and a second reflector 160. The transparent element 140 is adapted to let the first light beam L1 and the second light beam L2 pass through. In the present embodiment, the transparent element 140 is formed by a polygon transparent prism (e.g., a pentagonal prism), which is made of, for example, a material of glass or plastic. However, the prism type and the material of the transparent element 140 are not particularly limited by the invention.

In the present embodiment, the first reflector 150 and the second reflector 160 are disposed on the transparent element 140. The first reflector 150 and the second reflector 160 are opposite and not parallel to each other on the transparent element 140, and an included angle θ1 is provided between the first reflector 150 and the second reflector 160. In other words, the first reflector 150 and the second reflector 160 are separately disposed on two different surfaces of the transparent element 140, and the included angle θ1 is formed between an extending direction of the first reflector 150 and an extending direction of the second reflector 160. In the present embodiment, the included angle θ1 is determined according to the material of the transparent element 140 and a preset incident angle of the second reflector 160. In this way, the optical dichroic element 100 can occupy lesser space in other device and improve precision for transmitting light beams.

In the present embodiment, the first reflector 150 and the second reflector 160 are surface coatings of the transparent element 140. The first reflector 150 is coated with, for example, a mirror coating, and is thus able to reflect light beams with any wavelength. In this way, manufacturing costs of the optical dichroic element 100 can be reduced. The second reflector 160 is coated with a selective reflection coating for reflecting light beams with one single wavelength. In other words, the second reflector 160 reflects the light beam with a preset wavelength and allows transmission for the light beams with other wavelengths. The wavelength of the light beam restricted from passing through is identical to a wavelength of the transmitted first light beam L1. Accordingly, users can easily change the element in the devices for the required light beam with the preset wavelength in any devices using the optical dichroic element 100 of the present embodiment simply by replacing the optical dichroic element 100.

In the present embodiment, the first reflector 150 is adapted to reflect the first light beam L1 to the second reflector 160. The second reflector 160 is adapted to reflect the first light beam L1 and let the second light beam L2 pass through. Specifically, as a transmission path of the first light beam L1 in sequence, the first light beam L1 is first transmitted from the outside to the transparent element 140. Next, the first light beam L1 in the transparent element 140 is transmitted to the first reflector 150, where the first reflection occurs. Next, the first light beam L1 is reflected by the first reflector 150 to the second reflector 160, where the second reflection occurs. Then, the first light beam L1 is reflected by the second reflector 160 to the transparent element 140 and transmitted outside from a surface not having the first reflector 150. As a transmission path of the second light beam L2 in sequence, the second light beam L2 is transmitted from the outside and then passes through the second reflector 160 on the transparent element 140. An entering point of the second light beam L2 on the second reflector 160 is identical to an entering point of the first light beam L1 transmitted from the transparent element 140 on the second reflector 160. Next, the first light beam L1 and the second light beam L2 are combined into the mixed light beam LB, transmitted by the second reflector 160 to pass through the transparent element 140, and transmitted outside from a surface not having the first reflector 150 at last. In other words, the included angle θ1 between the first reflector 150 and the second reflector 160 can be properly designed so the second light beam L2 can be superposed with first light beam L1 and combined into the mixed light beam LB after passing through the second reflector 160.

Besides, in other embodiments, the optical dichroic element 100 can also be applied to serve as an optical beam-splitting element. For instance, in other embodiments, the mixed light beam LB can be separated into the first light beam L1 and the second light beam L2. First of all, the mixed light beam LB is provided and transmitted from the outside into the optical dichroic element 100. Here, the mixed light beam LB is formed by combining the first light beam L1 and the second beam L2 described above. The second reflector 160 is formed by coating on the transparent element 140. The wavelength of the light beam restricted by the second reflector 160 from passing through is identical to the wavelength of the first light beam L1 in the mixed light beam LB. Therefore, when the mixed light beam LB is transmitted from the transparent element 140 to the second reflector 160, the first light beam L1 in the mixed light beam LB is reflected by the second reflector 160 and the second light beam L2 in the mixed light beam LB passes through the second reflector 160 such that a beam-splitting effect can be achieved. In light of above, the optical dichroic element 100 of the invention can be used for beam-combining or beam-splitting based on user demands, which are not particularly limited by the invention.

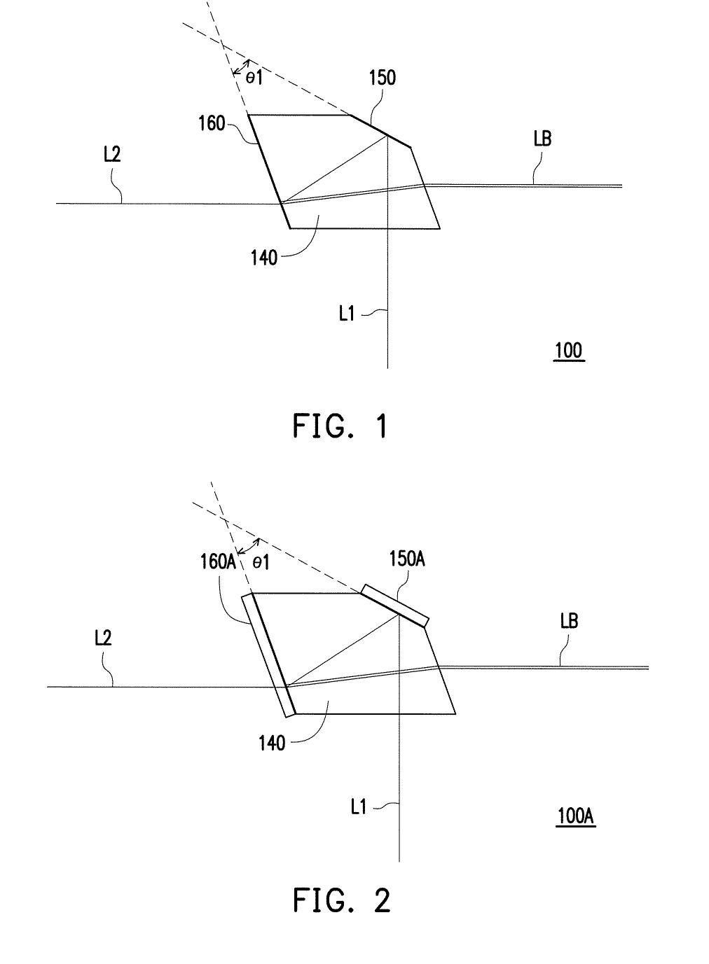

FIG. 2 is a schematic diagram illustrating an optical dichroic element according to another embodiment of the invention. With reference to FIG. 2, an optical dichroic element 100A of the present embodiment is similar to the optical dichroic element 100 of FIG. 1. The difference between the two is that, for example, a first reflector 150A and a second reflector 160A are framed by a transparent material sheet and surface coatings thereon. A material of the transparent material sheet may be identical to or different from the material of the transparent element 140, which is not particularly limited by the invention. Specifically, in the present embodiment, the first reflector 150A and the second reflector 160A are formed by a coating deposition on a transparent material and then the optical dichroic element 100A is formed by bonding said reflectors onto the transparent element 140. In other words, in the present embodiment, the desired first reflector 150A and the second reflector 160A can be fabricated in advance and assembled onto the transparent element 140 later to form the optical dichroic element 100A. By doing so, the transparent element 140 used can be less, and the transparent sheet can be replaced according to the wavelength of the transmitted second light beam L2 so as to improve the convenience for replacing the elements.

In other embodiments, the transparent element 140 can include a polygon frame (not illustrated). Accordingly, the first reflector 150A and the second reflector 160A described above can be disposed on the polygon frame without being further bonded onto the transparent element 140 such that the convenience for replacing the elements can be further improved. Besides, in other embodiments, the polygon frame may also be a frame of hollow-type. In other words, the transparent element 140 can also be directly formed by the polygon frame of hollow-type so the making of the optical dichroic element can then be completed by disposing the first reflector 150A and the second reflector 160A described above on the polygon frame. In this way, the material for manufacturing the elements can be further saved. Moreover, the type and the material of the polygon frame are not particularly limited by the invention.

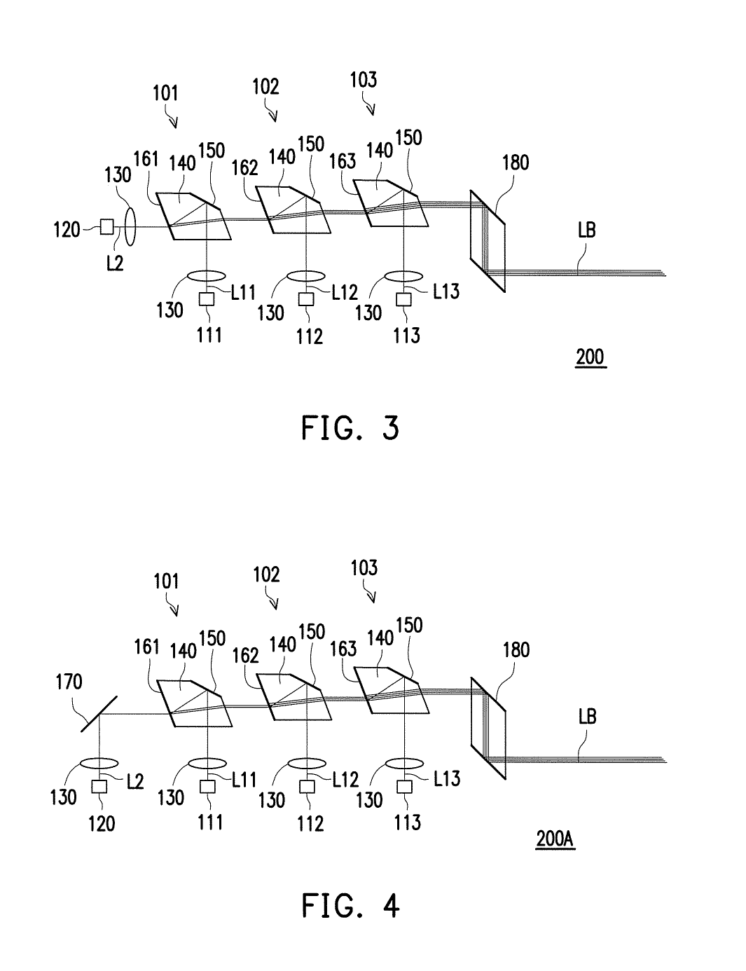

FIG. 3 is a schematic diagram illustrating an optical dichroic module according to an embodiment of the invention. With reference to FIG. 3, in the present embodiment, an optical dichroic module 200 is adapted to provide a mixed light beam LB. The optical dichroic module 200 includes a plurality of first light sources 111, 112 and 113, a second light source 120 and a plurality of optical dichroic elements 101, 102 and 103. The first light sources 111, 112 and 113 are adapted to provide a plurality of first light beams L11, L12 and L13. The second light source 120 is adapted to provide a second light beam L2. The optical dichroic elements 101, 102 and 103 are disposed on transmission paths of the first light beams L11, L12 and L13 respectively and are disposed on a transmission path of the second light beam L2. In the present embodiment, wavelengths of the first light beams L11, L12 and L13 and the second light beam L2 are different from one another. In other embodiments, the first light beams L11, L12 and L13 and the second light beam L2 may also be provided to the optical dichroic module by external light source components, respectively, which are not particularly limited by the invention.

In the present embodiment, the optical dichroic elements 101, 102 and 103 are similar to the optical dichroic element 100 of FIG. 1. The major difference is that, for example, wavelengths of the light beams restricted from passing through by second reflectors 161, 162 and 163 of the present embodiment are different from one another. In other words, in the optical dichroic elements 101, 102 and 103, coatings of the second reflectors 161, 162 and 163 are different from one another. For instance, in the present embodiment, for the second reflector 161 in the optical dichroic element 101, the wavelength of the light beam being restricted from passing through (i.e., reflected) is identical to a wavelength of the corresponding first light beam L11 transmitted. For the second reflector 162 in the optical dichroic element 102, the wavelength of the light beam being restricted from passing through (i.e., reflected) is identical to a wavelength of the corresponding first light beam L12 transmitted. For the second reflector 163 in the optical dichroic element 103, the wavelength of the light beam being restricted from passing through (i.e., reflected) is identical to a wavelength of the corresponding first light beam L13 transmitted.

Specifically, in the present embodiment, as a transmission path of the first light beam L11 in sequence, the first light beam L11 is transmitted from the outside into the optical dichroic element 101; reflected by the first reflector 150 in the optical dichroic element 101 to the second reflector 161; reflected by the second reflector 161 out of the optical dichroic element 101; and then transmitted passing through the optical dichroic elements 102 and 103. As a transmission path of the first light beam L12 in sequence, the first light beam L12 is transmitted from the outside into the optical dichroic element 102; reflected by the first reflector 150 in the optical dichroic element 102 to the second reflector 162; reflected by the second reflector 162 out of the optical dichroic element 102; and then transmitted passing through the optical dichroic element 103. As a transmission path of the first light beam L13 in sequence, the first light beam L13 is transmitted from the outside into the optical dichroic element 103; reflected by the first reflector 150 in the optical dichroic element 103 to the second reflector 163; and reflected by the second reflector 163 out of the optical dichroic element 103. As a transmission path of the second light beam L2 in sequence, the second light beam L2 is transmitted from the outside passing through the second reflectors 161, 162 and 163 on the optical dichroic elements 101, 102 and 103. Entering points of the second light beam L2 on the second reflectors 161, 162 and 163 are identical to entering points of the first light beams L11, L12 and L13 on the second reflectors 161, 162 and 163 respectively. Next, the first light beams L11, L12 and L13 and the second light beam L2 are combined into the mixed light beam LB, and transmitted outside from a surface not having the first reflector 150 in the optical dichroic element 103. In this way, the optical dichroic module 200 can occupy lesser space in other device and improve precision for transmitting light beams.

In the present embodiment, the optical dichroic module 200 further includes a plurality of collimating lens sets 130, which are respectively disposed on the transmission paths of the first light beams L11, L12 and L13 and the second light beam L2 and adapted to collimate the incident light beams L11, L12, L13 and L2 transmitted by the first light sources 111, 112 and 113 and the second light source 120 for entering the respective optical dichroic element. In this way, power and collimation of the mixed light beam LB combined by the multiple light beams can be improved.

In the present embodiment, the optical dichroic module 200 further includes a light beam translating element 180, which is disposed on a transmission path of the mixed light beam LB, and adapted to translate the mixed light beam LB. In this way, not only can offsets caused by combining multiple light beams be corrected, the mixed light beam LB can also shift to a desired position according the used device. In other embodiments, two planar reflectors parallel and opposite to each other (not illustrated) may also be disposed, and the two planar reflectors may be tilted in relative to a transmission direction of the mixed light beam LB so as to translate the mixed light beam LB, but the invention is not limited to the above.

FIG. 4 is a schematic diagram illustrating an optical dichroic module according to another embodiment of the invention. With reference to FIG. 4, an optical dichroic module 200A of the present embodiment is similar to the optical dichroic module 200 of FIG. 3. The major difference between the two is that, for example, the optical dichroic module 200A of the present embodiment further includes a reflective element 170, which is disposed on the transmission path of the second light beam L2 and adapted to reflect the second light beam L2 to the optical dichroic elements 101, 102 and 103. Accordingly, the second light source 120 and the first light sources 111, 112 and 113 can be collectively disposed on one single component (e.g., a substrate) to optimize configuration for light source devices.

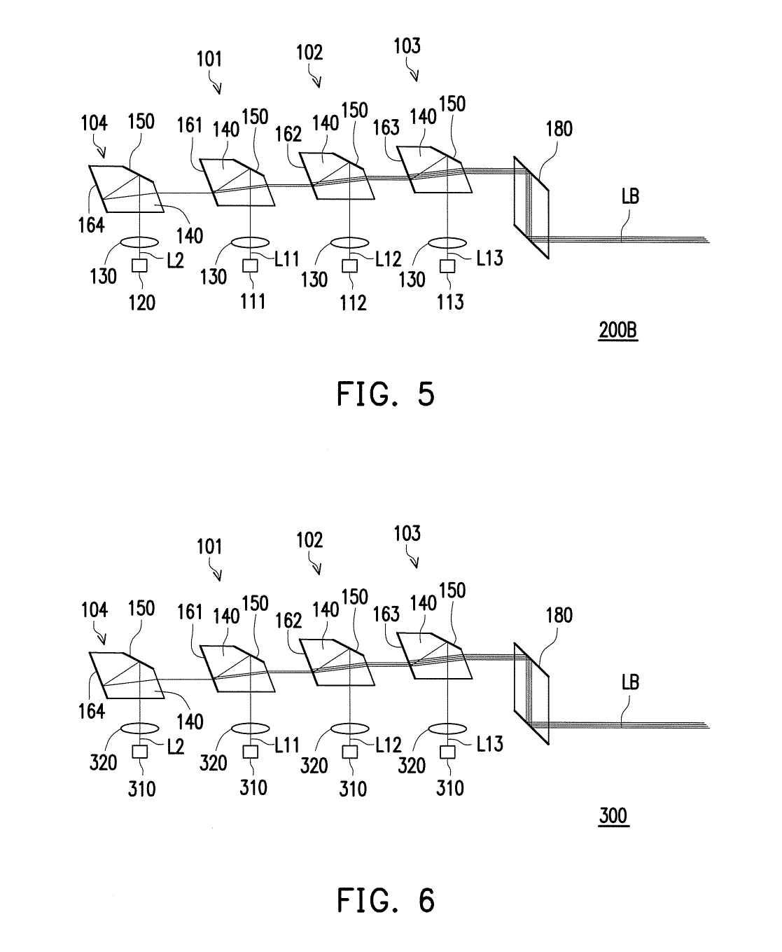

FIG. 5 is a schematic diagram illustrating an optical dichroic module according to yet another embodiment of the invention. With reference to FIG. 5, an optical dichroic module 200B of the present embodiment is similar to the optical dichroic module 200 of FIG. 3. The major difference between the two is that, for example, the optical dichroic module 200B of the present embodiment further includes an optical dichroic element 104, which is disposed on the transmission path of the second light beam L2. The optical dichroic element 104 is similar to the optical dichroic elements 101, 102 ad 103 of FIG. 3. The difference between them is that, for example, a wavelength of the light beam restricted from passing through (i.e., reflected) by a second reflector 164 of the optical dichroic element 104 is identical to the wavelength of the second light beam L2. Therefore, the second light beam L2 can be reflected by the optical dichroic element 104 to the optical dichroic elements 101, 102 and 103. Accordingly, the second light source 120 and the first light sources 111, 112 and 113 can be collectively disposed on one single component (e.g., a circuit board) to optimize configuration positions for light source devices.

Besides, in other embodiments, detailed structures of the optical dichroic elements 101, 102, 103 and 104 in the optical dichroic modules 200, 200A and 200B may also be optical dichroic elements selected from the other embodiments such as the optical dichroic element 100A illustrated in FIG. 2, but the invention is not limited thereto. On the other hand, to facilitate description for the invention of the present application, the optical dichroic modules 200, 200A and 200B are described with use of only three or four optical dichroic elements as an example. In other embodiments, the number of the optical dichroic elements in each of the optical dichroic modules 200, 200A and 200B may be changed to other numbers depending on the requirements from other device, which is not particularly limited by the invention.

FIG. 6 is a schematic diagram illustrating an optical dichroic module according to still another embodiment of the invention. With reference to FIG. 6, an optical dichroic module 300 of the present embodiment is similar to the optical dichroic module 200B of FIG. 5. The major difference between the two is that, for example, the optical dichroic module 300 of the present embodiment is adapted to receive the mixed light beam LB and separate the mixed light beam LB into the first light beams L11, L12 and L13 and the second light beam L2.

For instance, in the present embodiment, it is given that, the wavelength of the light beam restricted from passing through by the second reflector 163 in the optical dichroic element 103 is the wavelength of the first light beam L13; the wavelength of the light beam restricted from passing through by the second reflector 162 in the optical dichroic element 102 is the wavelength of the first light beam L12; the wavelength of the light beam restricted from passing through by the second reflector 161 in the optical dichroic element 101 is the wavelength of the first light beam L11; and the wavelength of the light beam restricted from passing through by the second reflector 164 in the optical dichroic element 104 is the wavelength of the second light beam L2.

Accordingly, when the mixed light beam LB is transmitted to the optical dichroic elements 101, 102, 103 and 104 from the optical translating element 180, the first light beams L11, L12 and L13 and the second light beam L2 are respectively reflected by the second reflectors 161, 162, 163 and 164 to the first reflector 150 in each of the optical dichroic elements 101, 102, 103 and 104 and transmitted out of the optical dichroic elements 101, 102, 103 and 104 in sequence to complete separating the light beams. In the present embodiment, sufficient teaching, suggestion, and implementation illustration regarding detailed transmission paths of the first light beams L11, L12 and L13 and the second light beam L2 in the mixed light beam LB can be obtained with reference to the foregoing embodiments, which are not repeated hereinafter.

Moreover, in the present embodiment, the optical dichroic module 300 further includes a plurality of light detectors 310 and a plurality of condensing lens sets 320, which are disposed on the transmission paths of the first light beams L11, L12 and L13 and the second light beam L2, respectively. The condensing lens sets 320 are adapted to focus the first light beams L11, L12 and L13 and the second light beam L2 separated from the mixed light beam LB to be transmitted into the respective light detector 310. In this way, the separated first light beams L11, L12 and L13 and the second light beam L2 can be further used or the respective light intensity thereof can be detected accordingly. In the present embodiment, enough teaching, suggestion, and implementation illustration for implementation of the light detectors 310 and the condensing lens sets 320 can be obtained with reference to common knowledge in the related art, which is not repeated hereinafter.

In summary, according to the embodiments of the invention, the optical dichroic element includes the transparent element, the first reflector and the second reflector. The first reflector reflects one of the first light beams or the second light beam to the second reflector. The first reflector and the second reflector are opposite and not parallel to each other on the transparent element. One included angle is provided between the first reflector and the second reflector. With aforementioned configuration, the optical dichroic module can have a simple structure, occupy lesser space in other device, and improve precision for transmitting light beams.

Although the present disclosure has been described with reference to the above embodiments, it will be apparent to one of ordinary skill in the art that modifications to the described embodiments may be made without departing from the spirit of the disclosure. Accordingly, the scope of the disclosure will be defined by the attached claims and not by the above detailed descriptions.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An optical dichroic element, adapted to combine a first light beam and a second light beam into a mixed light beam, and comprising:
a transparent element, adapted to let the first light beam and the second light beam pass through;
a first reflector, disposed on the transparent element; and
a second reflector, disposed on the transparent element, the first reflector being adapted to reflect the first light beam to the second reflector, the second reflector being adapted to reflect the first light beam and let the second light beam pass through, wherein the first reflector and the second reflector are opposite and not parallel to each other on the transparent element, and an included angle is provided between the first reflector and the second reflector.

2. The optical dichroic element according to claim 1, wherein wavelengths of the first light beam and the second light beam are different.

3. The optical dichroic element according to claim 1, wherein the transparent element comprises a polygon transparent prism.

4. The optical dichroic element according to claim 1, wherein the first reflector and the second reflector are surface coatings on the transparent element.

5. The optical dichroic element according to claim 1, wherein the transparent element comprises a polygon frame.

6. The optical dichroic element according to claim 1, wherein the first reflector and the second reflector are formed by a transparent sheet and surface coatings thereon.

7. The optical dichroic element according to claim 1, wherein the second reflector is adapted to reflect a preset wavelength light beam, and a wavelength of the preset wavelength light beam is identical to a wavelength of the corresponding first light beam.

8. The optical dichroic element according to claim 1, wherein the optical dichroic element is also adapted to separate the mixed light beam into the first light beam and the second light beam.

9. The optical dichroic element according to claim 1, wherein the included angle is determined according to the refractive index of the transparent element and a preset incident angle of the second reflector.

10. An optical dichroic module, adapted to provide a mixed light beam, and comprising:
a plurality of optical dichroic elements, adapted to combine a plurality of first light beams and a second light beam into the mixed light beam and disposed on a transmission path of the second light beam, each of the optical dichroic elements comprising:
a transparent element, adapted to let the first light beam and the second light beam pass through;
a first reflector, disposed on the transparent element; and
a second reflector, disposed on the transparent element, the first reflector being adapted to reflect one of the first light beams or the second light beam to the second reflector, wherein the first reflector and the second reflector are opposite and not parallel to each other on the transparent element, and an included angle is provided between the first reflector and the second reflector.

11. The optical dichroic module according to claim 10, wherein wavelengths of the first light beams and the second light beam are all different.

12. The optical dichroic module according to claim 10, wherein the transparent element comprises a polygon transparent prism.

13. The optical dichroic module according to claim 10, wherein the first reflector and the second reflector are surface coatings on the transparent element.

14. The optical dichroic module according to claim 10, wherein the transparent element comprises a polygon frame.

15. The optical dichroic module according to claim 10, wherein the first reflector and the second reflector are formed by a transparent sheet and surface coatings thereon.

16. The optical dichroic module according to claim 10, wherein the second reflector is adapted to reflect a preset wavelength light beam, and a wavelength of the preset wavelength light beam is identical to a wavelength of the corresponding one of the first light beams or the second light beam.

17. The optical dichroic module according to claim 10, further comprising a reflective element, disposed on the transmission path of the second light beam, and adapted to reflect the second light beam to the optical dichroic elements.

18. The optical dichroic module according to claim 10, further comprising a light beam translating element, disposed on a transmission path of the mixed light beam, and adapted to translate the mixed light beam.

19. The optical dichroic module according to claim 10, wherein the optical dichroic element is also adapted to separate the mixed light beam into one of the first light beams and the second light beam.

20. The optical dichroic module according to claim 10, wherein the included angle is determined according to the refractive index of the transparent element and a preset incident angle of the second reflector.

21. The optical dichroic module according to claim 10, further comprising:
a plurality of first light sources, adapted to provide the first light beams;
a second light source, adapted to provide the second light beam; and
a plurality of collimating lens sets, respectively disposed on transmission paths of the first light beams and the transmission path of the second light beam.

22. An optical dichroic module, adapted to separate a mixed light beam, and comprising:
a plurality of optical dichroic elements, adapted to receive the mixed light beam and separate the mixed light beam into a plurality of first light beams and a second light beam and disposed on a transmission path of the second light beam, each of the optical dichroic elements comprising:
a transparent element, adapted to let the first light beam and the second light beam pass through;
a first reflector, disposed on the transparent element; and
a second reflector, disposed on the transparent element, the second reflector being adapted to reflect one of the first light beams or the second light beam to the first reflector, wherein the first reflector and the second reflector are opposite and not parallel to each other on the transparent element, and an included angle is provided between the first reflector and the second reflector.
